(19) United States
(12) Patent Application Publication
(10) Pub. No.: US 2006/0285139 A1
(43) Pub. Date: Dec. 21, 2006

(54) Mixed-size copy printer system and method

(75) Inventors: Christopher N. Baunach, Lexington, KY (US); Scott T. Cramer, Lexington, KY (US); Phillip D. Erwin, Lexington, KY (US); William J.G. Flowers, Lexington, KY (US); Charles E. Grieshaber, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/156,219

(22) Filed: Jun. 17, 2005

(51) Int. Cl. G06F 3/12; G06K 15/00

(52) U.S. Cl. 358/1.12; 358/1.1; 358/474; 358/448

(57) ABSTRACT

A mixed-size copy printer system and method may include a scanner for collecting raw image data from and detecting a length of an original page from among a plurality of original pages of different lengths, a printer for printing an image scanned from an original page on a copy page, a controller including a plurality of stored print instructions and a RAM buffer, and an image processing unit, whereby the image processing unit may be configured to receive from the scanner the raw image data from the data indicative of a length of an original page scanned by the scanner, store the image data in the RAM buffer while the controller selects a print instruction from among the stored print instructions in response to the data indicative of the length of the original page scanned by the scanner, and the image processing unit sends the image data and the controller sends selected print instruction to the printer. The printer may also include width detection capability that enables the image processing unit to detect a variety of paper sizes of potentially different widths and lengths as well as distinguish between pages of the same size fed into the printer system's scanner in different orientations.

### FIELD OF THE INVENTION

The present invention relates to printing systems and, more particularly, to printing systems that include scanners that create image data that is subsequently processed and used by printers to print copies on copy paper.

### DESCRIPTION OF THE RELATED ART

Printing systems, such as those embodied in multi-function printers (“MFP”), include a scanning component, which may include a scanner that scans an original page, an image processing unit (“IPU”) that receives and processes the scanned image, and a printing unit that includes a print engine that receives the processed image data from the IPU and prints the processed image on a copy page. A controller coordinates the activities of the scanner, IPU and print engine. A schematic representation of such an MFP is shown in FIG. 1.

Mixed-size scanning refers to the ability of the scanning component of such a printing system to accept original pages in an associated automatic document feeder (“ADF”) of varying sizes and to determine the size of each page automatically when it is scanned. Scanners typically include automatic length detection (“ALD”) capabilities, and a scanner capable of ALD can detect the leading and trailing edges of an original page as it passes through the scanner or ADF and calculate the length of the original page.

A disadvantage of such ALD mechanisms is that they cannot calculate the length of an original page until after it has been scanned. However, if such a scanner is used to perform mixed-size copy, it is necessary to determine the size of the scanned page before the image data on the scanned page is processed by the IPU because the scale factor applied to the image data typically is dependent upon the ratio of the size of the scanned page (original page) to the size of the page on which the scanned image will be printed (print or copy page).

One solution to this problem is to construct scanners to have re-circulating ADF's that pass an original page through the ADF more than once. With such systems, the original page is fed through the ADF a first time to determine the length of the original page and allow the controller to calculate the scale factor and any other parameters that may depend on the paper size and to configure the IPU properly. The original page is then fed through the scanner a second time to generate actual scanned or image data. However, not only do such re-circulating systems result in a slower copy process and increased cost resulting from the added hardware needed, re-circulating scanners often invert the original page each time it passes through the ADF so that oftentimes an original page must make a third pass through the ADF in order to complete the scanning process in proper orientation.

Accordingly, there is a need for a mixed-size copy printer system that does not require re-circulating an original page.

### SUMMARY OF THE INVENTION

In one aspect, the mixed-size copy printer system may include a scanner for collecting raw image data from and detecting a length of an original page from among a plurality of original pages of different lengths, a printer for printing an image scanned from an original page on a copy page, a controller that includes a plurality of stored print instructions and an image processing unit that may include a RAM buffer. The image processing unit may be configured to receive from the scanner the raw image data and data indicative of a length of an original page scanned by the scanner and store the image in the RAM buffer while the controller selects a print instruction from among the stored print instructions in response to the data indicative of the length of the original page scanned by the scanner. The image processing unit may process the image data and send the image data from the RAM buffer to the printer. At the same time, the controller may send a selected print instruction to the printer. The scanner may include an automatic document feeder that accepts original pages of varying lengths.

The mixed-size copy printer system may scan original pages of varying lengths and copy the images from each of the original pages to copy pages of a single, standard size. In that configuration, the image processing unit may receive print image data and data indicative of the length of the original page, select an appropriate scale factor, and send the image data from the RAM buffer and scale factor to the printer. If the copy page is larger than the original page, the scale factor increases the image size to fill the original page. Conversely, if the copy page is smaller than the original page, the scale factor reduces the image, again so that it substantially fills the copy page.

In another aspect of the invention, the printer may include a plurality of paper trays, each having copy paper of a different size. The controller may receive image data and length data from the scanner and select a print instruction that is sent to the printer to actuate the printer to select appropriately sized paper from a selected one of the paper trays. In this aspect, if the scanned, original page is smaller than the smallest size paper in both dimensions, the print instruction generated by the controller may select the smallest paper available from the paper trays of the printer. If the scanned, original page is larger than the smallest mixed-size copy page present in the printer, but less than the largest mixed-size copy page present in the printer in both dimensions, the print instruction selected by the controller may instruct the printer to print the image on the largest mix-sized paper without scaling. If the scanned, original page is greater than the largest mixed-size paper present in the printer in one or both dimensions, the selected print instruction may cause the printer to print the scanned image on the largest mixed-sized paper in the printer with scaling sufficient to fit the image within the print window of the copy paper.

With each of the aforementioned aspects, the mixed-size copy printer system may accomplish the image processing with a single pass of the original page through the scanner. This may be achieved by providing the image processing unit with a RAM buffer that receives an entire page of scanned image data from the scanner. In a scanning process, the scanned image and data indicating the length of the original page may be transmitted from the scanner to the image processing unit and the scanned image data may be stored in the RAM buffer. While the image data is so stored, the controller may select an appropriate print instruction in response to the data received regarding the length of the original page. Then, the print instruction and image data may be sent by the image processing unit to the printer.

In a third aspect, the scanner of the mixed-size copy printer system may be adapted to detect the width of the original page. With that aspect, data indicative of the length and width of the original page are sent, along with the image data from the RAM buffer, to the image processing unit. The image processing unit utilizes the width information to set the appropriate clipping parameters in the image processing unit and allows the system to detect a variety of paper sizes of potentially different widths and lengths as well as distinguishing between pages of the same size fed into the scanner in different orientations.

Other objects and advantages of the mixed-size copy printer system and method will be apparent from the following description, the accompanying drawings and the appended claims.

### BRIEF DESCRIPTION OF THE DRAWINGS

FIG. 1 is a schematic showing a prior art mixed-size copy printer system; and

FIG. 2 is a schematic diagram of the disclosed mixed-size copy printer system.

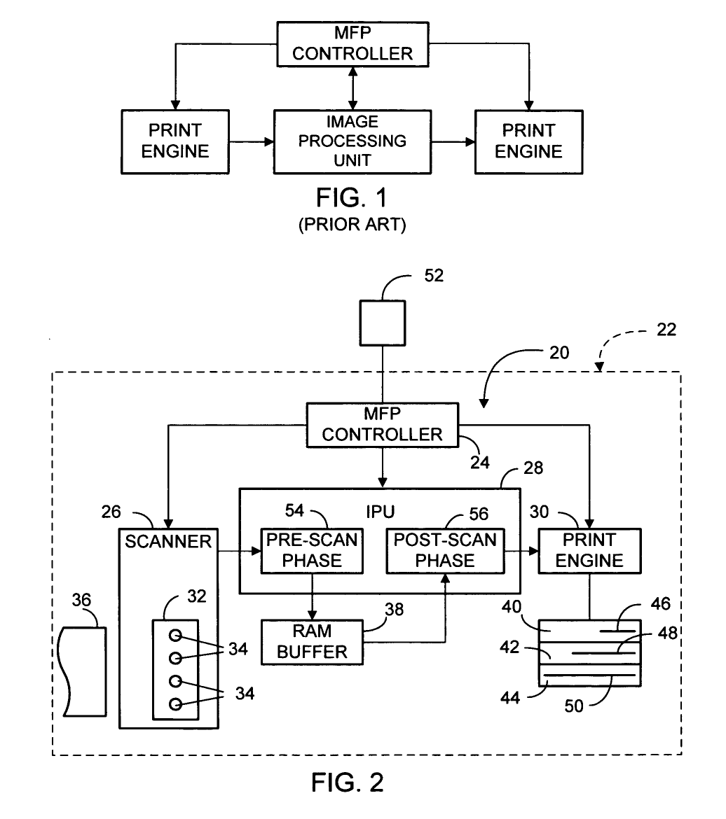

### DETAILED DESCRIPTION

As shown in FIG. 2, the mixed-size copy printer system, generally designated 20, may be incorporated in a multi-function printer (“MFP”) 22 that includes a controller 24, scanner 26, image processing unit 28, and print engine 30. It is within the scope of the disclosure to include other output components in the MFP, including without limitation a facsimile modem for sending faxes and a network connection for transmitting e-mail scans. It is also within the scope of the printer system 20 to provide physically discrete scanner 26, controller 24, image processing unit 28 and print engine 30 components, combined over a network or by a workstation, or to combine one or more of these elements, such as combining the scanner 26 with the controller 24 and image processing unit, or to place all the components within a single unit, such as a multi-function printer. Moreover, it is within the scope of the printer system 20 to combine the controller 24 and image processing unit 28 into a single, physical unit, in which the various functions of both, as will be described below, are performed by software.

The scanner 26 may include automatic length detection (“ALD”) and also may include a width detection component 32 that includes a plurality of electronic or mechanical sensors 34 for detecting the width of an original page 36. The scanner 26 also may include an automatic document feeder (“ADF”) component.

The image processing unit (“IPU”) 28 may include a RAM buffer 38 that is of a capacity sufficient to receive an entire page of image data from the scanner 26. The print engine 30 may include a plurality of paper trays 40, 42, 44, each shaped to hold and feed copy paper 46, 48, 50 of different sizes. The multi-function printer controller 24 coordinates the operation of the scanner 26, IPU 28, and print engine 30. The controller 24 includes a list of print instructions that may include selection of one of the paper trays 40, 42, 44. The MFP 22 also may include an options screen 52 with a user interface that allows a user to select various operating modes, as will be described herein.

In operation, an operator may select a “Mixed Sizes” value from a “Copy From” setting on a copy options screen 52 as part of the interface, in addition to standard paper sizes. Selecting the “Mixed Sizes” option indicates to the controller 24 that the original pages to be scanned may consist of a mixture of different paper sizes, each supported by the multi-function printer 22, such as, for example, letter size (8½″×11″) and legal size (8½″×14″). If the scanner 26 cannot resolve the size of each original page 36 to one of the aforementioned supported sizes, the controller 24 may display a “Scanner Jam” message indicating to the operator that an invalid paper size was loaded into the ADF component of the scanner.

The MFP 22 also may operate in an “Auto Size Match” configuration. In such a configuration, the operator selects “Auto Size Match” as a value in a “Copy To” setting on the options screen 52. In that setting, each original page 36 of the scanned document may be scaled up or down in size by the IPU 28 to be as large as possible while fitting entirely on a selected one of the output pages 46, 48, 50. The scale factor is calculated as follows:
Scale Factor=min (hc/hs, wc/ws)
where hs=height (or length) of the scanned paper (original page), ws=width of the scanned
paper, hc=height (length) of the copy paper and wc=width of the copy paper.

When “Auto Size Match” is selected with “Mixed Sizes,” the MFP 22 may attempt to print each page 36 of the document to be scanned on a page 46-50 of a selected same size. If a matching paper size is not available in the print engine 30, the IPU is configured to actuate the print engine to select paper according to the following table.

TABLE I

| | |
|---|---|
| Sensed Scan Size Is: | Print On: |
| Less than the smallest mixed size paper | smallest present mixed size |
| present in printer in both dimensions | paper without scaling |
| Greater than smallest mixed size paper | largest present mixed size |
| present in printer in one dimension but less | paper without scaling |
| than largest mixed size paper present in the | |
| printer in both dimensions | |
| Greater than largest mixed size paper present | largest present mixed size |
| in printer in one or both dimensions | paper with scaling |

In order to perform the mixed copy functions described above with original pages 36 of various lengths before the scan is initiated, it may be necessary to buffer the raw image data before it is processed by the IPU 28. Accordingly, the image processing function is divided into two phases. In the first phase, the IPU 28 is configured to clip incoming scan data received from the scanner 26 to the common width of the supported set of mixed paper sizes 46, 48, 50. This clipped data may then deposited in the RAM buffer 38. Once all scanned data has been received, the length of the original page 36 can be queried from the scanner 26 or inferred from the amount of data received into the RAM buffer 38. The controller 24 then reconfigures the IPU 28 with the appropriate scaling factor and other parameters based on the input and output paper sizes, instructs the IPU to process the data in the RAM buffer and deliver it to the print engine 30, and sends the appropriate print instructions to the print engine.

Accordingly, as shown in FIG. 2, the IPU 28 may be divided into modules performing a prescan phase 54 and a post-scan phase 56. Again, with the prescan phase 54, the incoming scan data from the scanner 26 may be clipped horizontally and stored in the RAM buffer 38. In the post-scan phase 56, the stored image data in the RAM buffer 38 may be further processed, which may include scaling, before it is sent to the print engine 30.

Another aspect of the mixed-size copy print system is that it may accommodate MFP's 22 that include width detection components 32. When an original page 36 is fed into the scanner 26, a number of sensors 34 corresponding to the width of page 36 are activated, and that allows the scanner to resolve the width of the original page to a set of supported paper sizes. Since this information is available before the scan begins, the controller 24 may use that information on width to set the appropriate clipping parameters in the IPU 28 for the prescan processing phase 54. This may allow the system 20 to detect a variety of paper sizes of potentially different widths and lengths as well as distinguishing between pages 36 of the same size fed into the ADF of the scanner 26 in different orientations (i.e., long edge or short edge).

It should be noted that the mixed-size copy system may be used to accept original paper and print on print media of all types, including without limitation bond paper, vellum, transparencies, card stock, photographic paper and the like. Furthermore, when the terms “paper” or “page” are used herein, such terms encompass all such media.

While the methods and forms of apparatus disclosed may constitute preferred forms of the mixed-size copy printer system, it is to be understood that other forms and methods may be employed without departing from the scope of the appended claims.

What is claimed is:

1. A mixed-size copy printer system comprising:
a scanner for collecting raw image data from and detecting a length of an original page from among a plurality of original pages of different lengths;
a printer for printing an image scanned from an original page on a copy page; and;
a controller including a plurality of stored print instructions and a RAM buffer, whereby the controller is configured to receive from the scanner the raw image data from and data indicative of a length of an original page scanned by the scanner, store the image data in the RAM buffer while the controller selects a print instruction from among the stored print instructions in response to the data indicative of the length of the original page scanned by the scanner, and send the image data and selected print instruction to the printer.

2. The mixed-size copy printer system of claim 1, wherein the printer includes a plurality of paper trays for holding different-sized copy paper; and the selected print instruction actuates the printer to select copy paper from a selected one of the plurality of paper trays.

3. The mixed-size copy printer system of claim 2, wherein the selected print instruction actuates the printer to select copy paper from the selected one of the plurality of paper trays that most approximately matches the original page in length.

4. The mixed-size copy printer system of claim 2, wherein the stored print instructions include:
a first print instruction that actuates the printer to print on a shortest copy paper available in the plurality of paper trays without scaling,
a second print instruction that actuates the printer to print on a longest copy paper available in the plurality of paper trays without scaling; and
a third print instruction that actuates the printer to print on the longest copy paper available in the plurality of paper trays and scale the scanned image to fit the longest copy paper available in the plurality of paper trays.

5. The mixed-size copy printer system of claim 4, wherein the controller is configured such that if a matching paper size is not available in the printer and a length of the original page is less than the shorted copy paper in the plurality of paper trays, the controller is configured to select the first print instruction as the selected print instruction; if a matching paper size is not available in the printer and the length of the original page is greater than the shortest copy paper in the paper trays but less than the longest copy paper in the paper trays, the controller is configured to select the second print instruction as the selected print instruction; and if a matching paper size is not available in the printer and a length of the original page is greater than a length of the longest copy paper in the plurality of paper trays, the controller is configured to select the third print instruction as the selected print instruction.

6. The mixed-size copy printer system of claim 4, wherein the third print instruction includes applying a scale factor according to the formula: scale factor=min (hc/hs, wc/ws), where hs is the length of the original page, ws is the width of the original page, hc is the length of the copy paper and wc is the width of the copy paper.

7. The mixed-size copy printer system of claim 1, wherein the RAM buffer is sized to hold image data from an entire original page.

8. The mixed-size copy printer system of claim 1, wherein the printer is configured to print only a single size copy page; and the selected print instruction includes a scale factor such that the scanned image substantially fills the copy page printed by the printer.

9. The mixed-size copy printer system of claim 8, wherein the scale factor is selected according to the formula: scale factor=min (hc/hs, wc/ws), where hs is the length of the original page, ws is the width of the original page, he is the length of the copy paper and we is the width of the copy paper.

10. The mixed-size copy printer system of claim 1, wherein the scanner includes a width detection mechanism; and the image processing unit is configured to receive data indicative of a width of an original page scanned by the scanner and in response thereto set clipping parameters.

11. A method for making copies of images from original pages of mixed size comprising:
scanning an original page with a scanner to collect raw image data and detecting a length of the original page from among a plurality of original pages of different lengths;
receiving from the scanner into an image processing unit raw image data and data indicative of a length of the original page,
storing the image data in a RAM buffer in the image processing unit;
while the image data is stored in the RAM buffer, selecting a print instruction from among a plurality of stored print instructions in response to the data indicative of the length of the original page scanned by the scanner;
sending the image data and selected print instruction to a printer; and
printing the image scanned from the original page on a copy page in response to the selected print instruction.

12. The method of claim 11, further comprising selecting copy paper of a predetermined size from a paper try among a plurality of paper trays in the printer holding different-sized copy paper in response to the selected print instruction.

13. The method of claim 12, further comprising actuating the printer to select copy paper from the selected one of the plurality of paper trays that most approximately matches the original page in length.

14. The method of claim 13, further comprising storing print instructions including:
a first print instruction that actuates the printer to print on a shortest copy paper available in the plurality of paper trays without scaling,
a second print instruction that actuates the printer to print on a longest copy paper available in the plurality of paper trays without scaling and
a third print instruction that actuates the printer to print on the longest copy paper available in the plurality of paper trays and scale the scanned image to fit the longest copy paper available in the plurality of paper trays.

15. The method of claim 14, further comprising actuating the printer so that if a matching paper size is not available in the printer and a length of the original page is less than the shortest copy paper in the plurality of paper trays, the first print instruction is selected as the selected print instruction; if a matching paper size is not available in the printer and the length of the original page is greater than the shortest copy paper in the paper trays but less than the longest copy paper in the paper trays, the second print instruction is selected as the selected print instruction; and if a matching paper size is not available in the printer and a length of the original page is greater than a length of the longest copy paper in the plurality of paper trays, the third print instruction is selected as the selected print instruction.

16. The method of claim 14 wherein the third print instruction includes applying a scale factor according to the formula: scale factor=min (hc/hs, wc/ws), where hs is the length of the original page, ws is the width of the original page, hc is the length of the copy paper and we is the width of the copy paper.

17. The method of claim 11, wherein the storing step includes storing image data a RAM buffer sized to hold image data from an entire original page.

18. The method of claim 11, wherein the printing step includes printing to only a single size copy page; and the sending step includes sending a selected print instruction that includes a scale factor such that the scanned image substantially fills the copy page printed by the printer.

19. The method of claim 18, including selecting the scale factor according to the formula: scale factor=min (he/hs, wc/ws), where hs is the length of the original page, ws is the width of the original page, hc is the length of the copy paper and wc is the width of the copy paper.

20. A mixed-size copy printer system comprising:
a scanner for collecting raw image data from and detecting a length of an original page from among a plurality of original pages of different lengths;
a printer for printing an image scanned from an original page on a copy page, the printer including a plurality of paper trays for holding different-sized copy paper; and
a controller including a plurality of stored print instructions, the stored print instructions including
a first print instruction that actuates the printer to print on a shortest copy paper available in the plurality of paper trays without scaling,
a second print instruction that actuates the printer to print on a longest copy paper available in the plurality of paper trays without scaling and
a third print instruction that actuates the printer to print on the longest copy paper available in the plurality of paper trays and scale the scanned image to fit the longest copy paper available in the plurality of paper trays;
an image processing unit including a RAM buffer being sized to hold image data from an entire original page, whereby the image processing unit is configured to receive from the scanner the raw image data from and data indicative of a length of an original page scanned by the scanner, store the image data in the RAM buffer while the image processing unit selects a print instruction from among the stored print instructions in response to the data indicative of the length of the original page scanned by the scanner, and send the image data and selected print instruction to the printer, the selected print instruction actuating the printer to select copy paper from a selected one of the plurality of paper trays, wherein the image processing unit is configured such that if a matching paper size is not available in the printer and a length of the original page is less than a shortest copy paper in the plurality of paper trays, the image processing unit is configured to select the first print instruction as the selected print instruction; if a matching paper size is not available in the printer and the length of the original page is greater than the shortest copy paper in the paper trays but less than the longest copy paper in the paper trays, the image processing unit is configured to select the second print instruction as the selected print instruction; and if a matching paper size is not available in the printer and a length of the original page is greater than a length of the longest copy paper in the plurality of paper trays, the image processing unit is configures to select the third print instruction as the selected print instruction.
